(19) United States
(12) Patent Application Publication
(10) Pub. No.: US 2026/0340362 A1
(43) Pub. Date: Oct. 29, 2026

(54) MANAGING GENERATIVE ARTIFICIAL INTELLIGENCE (AI) MODEL OUTPUTS USING AN UN-INFERENCING BASED OUTPUT GENERATION PROCESS

(71) Applicant: Dell Products L.P., Round Rock, TX (US)

(72) Inventors: OFIR EZRIELEV, Be'er Sheva (IL); HANNA YEHUDA, Acton, MA (US); ANNE-MARIE MCREYNOLDS, San Jose, CA (US)

(21) Appl. No.: 19/192,027

(22) Filed: Apr. 28, 2025

(51) Int. Cl. G06N 3/0475; G06F 16/3329; G06F 16/9536

(52) U.S. Cl. CPC G06N 3/0475; G06F 16/33295; G06F 16/9536

(57) ABSTRACT

Methods and systems for providing computer-implemented services using generative AI models are disclosed. To do so, a prompt for a generative AI model may be obtained from a user. Portions of the prompt may be obtained, which may include a first portion indicating a desired information content and a second portion indicating an undesired information content. A contextual information retrieval process may be performed using a contextual information repository to obtain first contextual information for the first portion and second contextual information for the second portion. The second contextual information may be filtered using the undesired information content as a positive filter to obtain filtered contextual information for the second portion. Generation of an output by the generative AI model may be initiated using the prompt, the first contextual information, and the filtered contextual information to complete an un-inferencing based output generation process.

### FIELD

Embodiments disclosed herein relate generally to providing computer-implemented services using generative artificial intelligence (AI) models. More particularly, embodiments disclosed herein relate to managing generative AI model outputs using an un-inferencing based output generation process.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2D show flow diagrams illustrating data flows in accordance with an embodiment.

FIG. 3 shows a flow diagram illustrating a method for providing computer-implemented services using generative AI models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using generative AI models. The generative AI models may include large language models (LLMs) that may generate outputs when provided with prompts. The outputs may be used, at least in part, to provide the computer-implemented services. For example, the outputs may be provided to a downstream consumer (e.g., a user) and the downstream consumer may use the outputs to make decisions.

The outputs may be provided to downstream consumers as part of chat sessions (e.g., generative AI sessions) with the downstream consumers. A chat session may include any exchange of prompts from a first entity (e.g., a downstream consumer) and outputs from a second entity (e.g., a generative AI model). For example, a chat session may be initiated by a downstream consumer (e.g., a client, a customer) via a graphical user interface (GUI). The downstream consumer may enter a prompt, which may be displayed in a chat window of the GUI. The prompt may be used as ingest for a generative AI model and the output generated by the generative AI model may be added to the chat window as a response from a chat agent (e.g., a virtual assistant). The downstream consumer may enter additional prompts during the chat session and all prompts and outputs may be recorded on the chat window during the chat session.

The generative AI model may include a retrieval-augmented generation (RAG) architecture, and portions of the prompt may be used to obtain contextual information for the prompt. The contextual information and the prompt may be used to generate an ingest package, and the ingest package may be used by the generative AI model to generate an output responsive to the prompt. The contextual information provided to the generative AI model as part of the ingest package may influence the output generated by the generative AI model. However, the contextual information obtained for the prompt may include information content that the downstream consumer does not desire to be used to generate the output. As a result, the output may not meet expectations of the downstream consumer. Consequently, computer-implemented services provided using the output may be negatively impacted.

To improve a user's (e.g., a downstream consumer's) experience and increase a likelihood of providing outputs that meet expectations of the downstream consumer, an un-inferencing based output generation process may be performed. During the un-inferencing based output generation process, portions of the prompt may be obtained (e.g., based on user sentiment indicated by the prompt). The portions of the prompt may include: (i) a first portion indicating a desired information content, and (ii) a second portion indicating an undesired information content.

A contextual information retrieval process may be performed using a contextual information repository (e.g., a retrieval-augmented generation (RAG) database) to obtain contextual information for each portion of the prompt. Performing the contextual information retrieval process may include: (i) performing a first contextual information retrieval process to obtain first contextual information for the first portion, and (ii) performing a second contextual information retrieval process to obtain second contextual information for the second portion.

The second contextual information may then be filtered to obtain filtered contextual information for the second portion of the prompt. For example, the second contextual information may be filtered using the undesired information content as a positive filter (and/or using the desired information content as a negative filter). By doing so, a portion of the second contextual information that relates to the desired information content may be removed from the second contextual information. The first contextual information, the filtered contextual information, and the prompt may be used to initiate generation of an output by the generative AI model. The output may be used to provide the computer-implemented services.

Thus, embodiments disclosed herein may provide an improved method for providing computer-implemented services using generative AI models. To provide the computer-implemented services as desired by downstream consumers, portions of a prompt for a generative AI model may be obtained (e.g., based on user sentiments), and contextual information may be obtained for each portion of the prompt. At least a portion of the contextual information may then be filtered prior to use in an ingest package for the generative AI model. Doing so may increase a likelihood that outputs generated as part of the chat session are accurate and relevant to the needs of the downstream consumer.

In an embodiment, a method for providing computer-implemented services using generative AI models is provided. The method may include: obtaining, from a user, a prompt for a generative AI model of the generative AI models; obtaining portions of the prompt, the portions including: a first portion indicating a desired information content, and a second portion indicating an undesired information content; performing, using a contextual information repository, a contextual information retrieval process to obtain first contextual information for the first portion and second contextual information for the second portion; filtering, using the undesired information content as a positive filter, the second contextual information to remove a portion of the second contextual information that relates to the desired information content to obtain filtered contextual information for the second portion; initiating generation of an output by the generative AI model using the prompt, the first contextual information, and the filtered contextual information to complete an un-inferencing based output generation process; and using at least the output to provide the computer-implemented services.

Performing the contextual information retrieval process may include: performing a first contextual information retrieval process to obtain the first contextual information for the first portion; and performing a second contextual information retrieval process to obtain the second contextual information for the second portion, wherein the first contextual information retrieval process and the second contextual information retrieval process being independent similarity based search processes with respect to the first portion and the second portion, respectively.

Performing the second contextual information retrieval process may include: performing an embedding generation process for the second portion to obtain an embedding, the embedding including an inference model-ingestible representation of the second portion; identifying data chunks from the contextual information repository that are similar to the embedding based on similarity criteria; ranking the data chunks based on similarity to the embedding to obtain a ranking; and selecting at least one data chunk to be used as the second contextual information based on at least the ranking.

Filtering the second contextual information may include: making a determination regarding whether a second portion of the second contextual information relates to the desired information content; in a first instance of the determination in which the second portion of the second contextual information does relate to the desired information content: removing the second portion of the second contextual information to obtain the filtered contextual information; and in a second instance of the determination in which the second portion of the second contextual information relates to the undesired information content: retaining the second portion of the second contextual information to obtain the filtered contextual information.

Identifying the portions of the prompt may include: identifying, using a second generative AI model, user sentiments for the portions of the prompt, the user sentiments indicating the desired information content and the undesired information content; and obtaining the first portion and the second portion based on the user sentiments.

Initiating generation of the output by the generative AI model may include: obtaining, using the prompt, the first contextual information, and the filtered contextual information, an ingest package for the generative AI model; and providing the ingest package to the generative AI model as input to be used to generate the output.

Initiating generation of the output by the generative AI model may also include: performing, using the second portion, an un-inferencing process to obtain a temporarily updated instance of the generative AI model, the temporarily updated instance of the generative AI model being less influenced by the second portion than the generative AI model.

Performing the un-inferencing process may include at least one action selected from a list of actions consisting of: negating embeddings corresponding to the second portion to obtain the temporarily updated instance of the generative AI model; adding, based on the second portion, a negation layer to an input layer of the generative AI model to obtain the temporarily updated instance of the generative AI model; adding, based on the second portion, the negation layer prior to an attention module of the generative AI model to obtain the temporarily updated instance of the generative AI model; and adding, based on the second portion, the negation layer to a hidden layer of the attention module to obtain the temporarily updated instance of the generative AI model.

Obtaining the prompt for the generative AI model may include: obtaining, from the user, the prompt as part of a chat session via interactions between the user and a graphical user interface (GUI).

The generative AI model may be a large language model (LLM).

The prompt may include at least one type of data modality selected from a list of types of data modalities consisting of: (i) text, (ii) image, (iii) video, and (iv) audio.

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

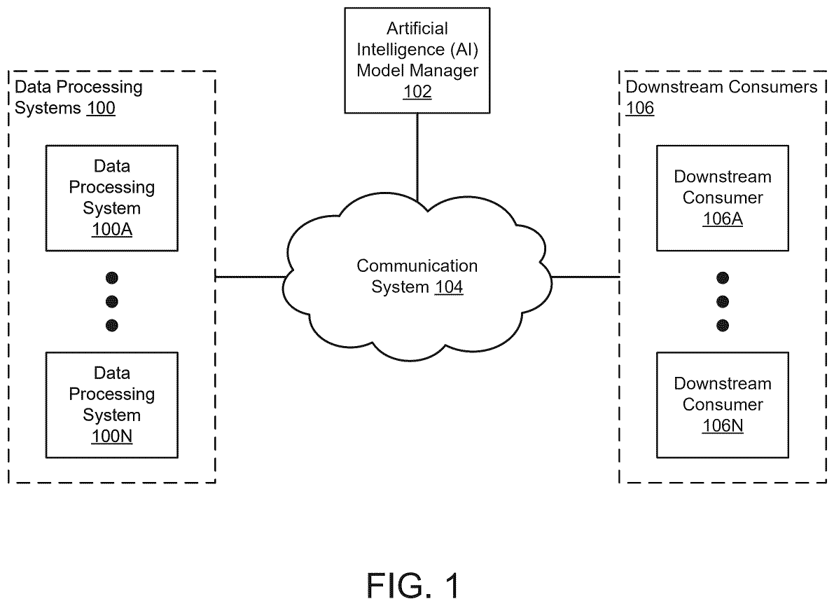

Turning to FIG. 1, a block diagram illustrating a system in accordance with an embodiment is shown. The system shown in FIG. 1 may provide for management of data processing systems that may provide, at least in part, computer-implemented services (e.g., to users of the system and/or devices operably connected to the system).

The computer-implemented services may include any type and quantity of computer-implemented services. The computer-implemented services may include, for example, database services, data processing services, electronic communication services, inference generation services, and/or any other services that may be provided using one or more computing devices. The computer-implemented services may be provided by, for example, data processing systems 100, AI model manager 102, downstream consumers 106, and/or any other type of devices (not shown in FIG. 1). Other types of computer-implemented services may be provided by the system shown in FIG. 1 without departing from embodiments disclosed herein.

The computer-implemented services may be provided, at least in part, using generative AI models and/or outputs obtained using the generative AI models. To do so, data processing systems 100 and/or AI model manager 102 may host any number of generative AI models.

To obtain the outputs, the generative AI models may be trained, using training data, to generate the outputs when provided with prompts (e.g., ingest data). The generative AI models may include large language models (LLMs) and, therefore, the outputs may include new instances of data created by the generative AI models based on learned associations from and/or an understanding of the training data. For example, the generative AI models may be trained using unstructured data, such as stories, essays, audio transcription, video description, and/or other types of human interpretable text, to generate outputs of the same. The outputs may be provided to downstream consumers 106 (e.g., client devices, data processing systems that manage computer systems and/or production systems) as part of providing the computer-implemented services.

The outputs may be provided to downstream consumers 106 as part of generative AI sessions (e.g., chat sessions) with downstream consumers 106. A chat session may include, for example, a real-time interaction between two entities (e.g., a downstream consumer and an AI agent) during which information is exchanged. The information may include prompts provided by the downstream consumer and outputs generated by a generative AI model. The prompts and the outputs may include any type of data modality (e.g., images, audio, video, text).

A chat session may be accessed by a downstream consumer (e.g., 106A) via a graphical user interface (GUI) used as part of, for example, a customer support service, a data analysis service, a content creation service, and/or other services. Downstream consumer 106A may provide a prompt and the AI agent may provide an output that is responsive to the prompt. The AI agent may include a software program that manages, at least in part, operation of the generative AI model and that serves as a proxy for the generative AI model in a simulated conversation with downstream consumer 106A during the chat session.

The generative AI model may include a retrieval-augmented generation (RAG) architecture, and portions of the prompt may be used to obtain contextual information for the prompt. The contextual information and the prompt may be used to generate an ingest package, and the ingest package may be used by the generative AI model to generate an output responsive to the prompt. The contextual information provided to the generative AI model as part of the ingest package may influence the output generated by the generative AI model.

However, the contextual information obtained for the prompt may include information content that downstream consumer 106A does not desire to be used to generate the output. As a result, the output may not meet expectations of downstream consumer 106A. Consequently, computer-implemented services provided using the output may be negatively impacted.

In general, embodiments disclosed herein may provide methods, systems, and/or devices for improving a likelihood that an output generated by a generative AI model based on a prompt provided by a user meets the expectations of the user. To do so, an un-inferencing based output generation process may be performed. During the un-inferencing based output generation process, portions of the prompt may be obtained (e.g., based on user sentiment indicated by the prompt). The portions of the prompt may include: (i) a first portion indicating a desired information content, and (ii) a second portion indicating an undesired information content.

A contextual information retrieval process may be performed using a contextual information repository (e.g., a retrieval-augmented generation (RAG) database) to obtain contextual information for each portion of the prompt. For example, a first contextual information retrieval process may be performed to obtain first contextual information (e.g., relating to the desired information content) for the first portion of the prompt. A second contextual information retrieval process may be performed to obtain second contextual information (e.g., relating to the undesired information content) for the second portion of the prompt.

The second contextual information may then be filtered to obtain filtered contextual information for the second portion of the prompt. For example, the second contextual information may be filtered using the undesired information content as a positive filter (and/or using the desired information content as a negative filter). By doing so, a portion of the second contextual information that relates to the desired information content may be removed from the second contextual information. The first contextual information, the filtered contextual information, and the prompt may be used to initiate generation of an output by the generative AI model. The output may be used to provide the computer-implemented services.

Thus, embodiments disclosed herein may improve processes of providing outputs generated by generative AI models based on prompts to downstream consumers of the outputs (e.g., users). The prompts may be divided into portions, and contextual information may be obtained for each of the portions. The contextual information may then be filtered to improve a likelihood that the contextual information includes information content usable to service the prompts as desired by the downstream consumers. Consequently, a likelihood of generating outputs that meet the expectations of the downstream consumers may be increased, and computer-implemented services may be provided using at least the outputs as desired.

To provide the above noted functionality, the system of FIG. 1 may include data processing systems 100, AI model manager 102, downstream consumers 106, and communication system 104. Each of these components is discussed below.

Data processing systems 100 may provide all, or a portion of, the computer-implemented services. Data processing systems 100 may include any number of data processing systems (e.g., 100A-100N) that may provide output generation services to downstream consumers 106. For example, a downstream consumer (e.g., 106A) may subscribe to output generation services provided by data processing system 100A and downstream consumer 106A may provide prompts (e.g., from users such as clients, owners of downstream consumer 106A, employees of a company that owns downstream consumer 106A) to data processing system 100A as part of the subscribed services.

As part of providing the computer-implemented services, data processing systems 100 may: (i) obtain ingest packages (e.g., prompts, contextual information for the prompts) for generative AI models (e.g., hosted and/or operated by data processing systems 100), (ii) feed the ingest packages into a generative AI model to obtain outputs, and (iii) provide the outputs to downstream consumers as part of providing computer-implemented services to the downstream consumers.

Data processing systems 100 may provide chat session services to downstream consumers 106. For example, one or more of downstream consumers 106 may host AI agents that manage chat sessions with users (e.g., downstream consumers). A record of the chat sessions may be displayed, via the GUI, on a user's device (e.g., one or more of downstream consumers 106).

As part of providing the computer-implemented services, data processing systems 100 may also perform un-inferencing based output generation processes. During the un-inferencing based output generation processes, outputs may be generated by a generative AI model based on prompts obtained from downstream consumers (e.g., users). Performing the un-inferencing based output generation process may include: (i) obtaining, from a user (e.g., downstream consumer 106A), prompts for a generative AI model, (ii) obtaining portions of the prompts (e.g., using a second generative AI model and/or via other methods), (iii) performing, using a contextual information repository (e.g., a RAG database), contextual information retrieval process for the portions of the prompts to obtain contextual information for the portions, (iv) filtering the contextual information for the portions (e.g., using desired and/or undesired information content as filters) to obtain filtered contextual information for the portions, (v) initiating generation of outputs by the generative AI model using the prompts, the contextual information, and/or the filtered contextual information to complete the un-inferencing based output generation process, and/or (vi) performing other actions.

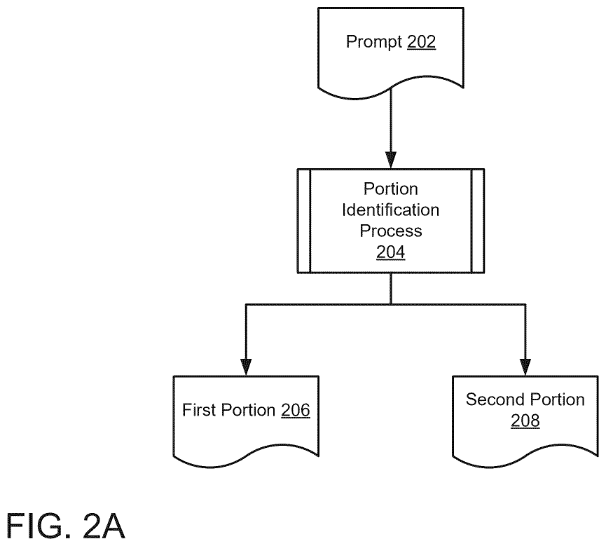

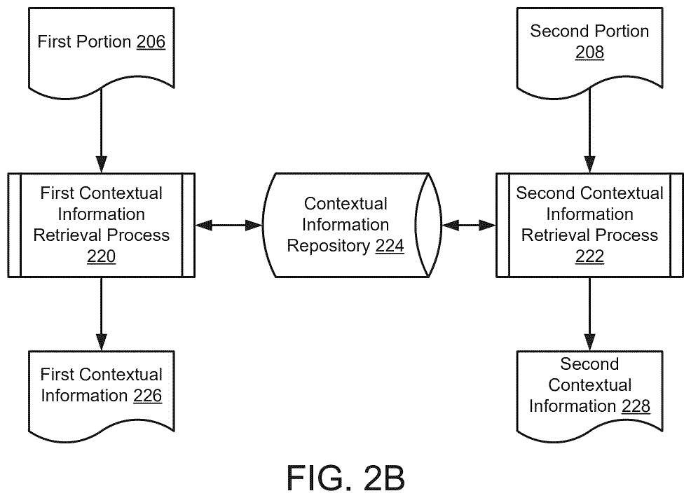

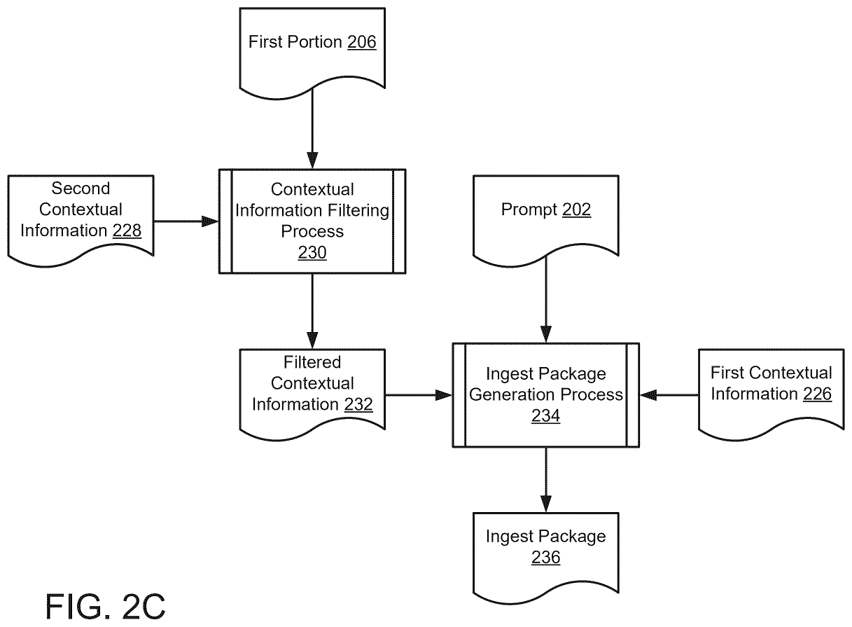

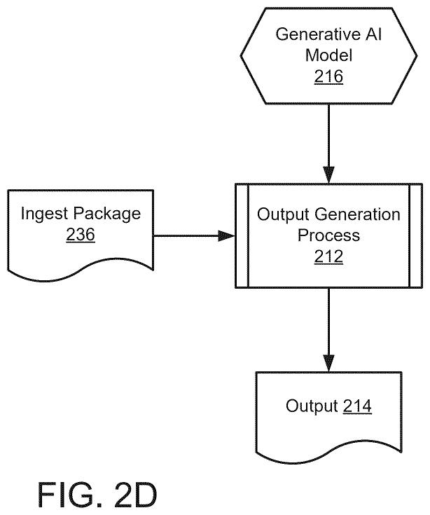

Refer to FIG. 2A for additional details regarding obtaining prompts and the portions of the prompts. Refer to FIG. 2B for additional details regarding performing the contextual information retrieval processes. Refer to FIG. 2C for additional details regarding filtering the contextual information. Refer to FIG. 2D for additional details regarding obtaining outputs using the generative AI model.

AI model manager 102 may manage any number of AI models. For example, AI model manager 102 may: (i) obtain training data for AI models, (ii) train any number of AI models to obtain trained AI models, (iii) deploy trained AI models to other entities (e.g., data processing systems 100), (iv) update and/or modify trained AI models (e.g., fine-tune trained AI models based on additional training and/or production data), and/or (v) provide other AI model management services.

For example, AI model manager 102 may cooperatively provide at least a portion of the computer-implemented services to data processing systems 100 by: (i) obtaining training data from downstream consumers 106, (ii) training one or more AI models (e.g., generative AI models) using at least the training data obtained from downstream consumers 106 to obtain one or more trained AI models, (iii) deploying the one or more trained AI models to data processing systems 100 for use in providing output generation services for downstream consumers 106, and/or (iv) performing other actions.

Downstream consumers 106 (e.g., also referred to as users) may provide and/or consume all, or a portion of, the computer-implemented services. Downstream consumers 106 may include any number of downstream consumers (e.g., 106A-106N) and may include, for example, businesses, individuals, and/or devices (e.g., data processing systems) that may obtain outputs and/or other information based on the outputs as part of receiving the computer-implemented services. For example, downstream consumers 106 may include persons, software programs, and/or any other entity which may obtain the outputs as part of receiving the computer-implemented services.

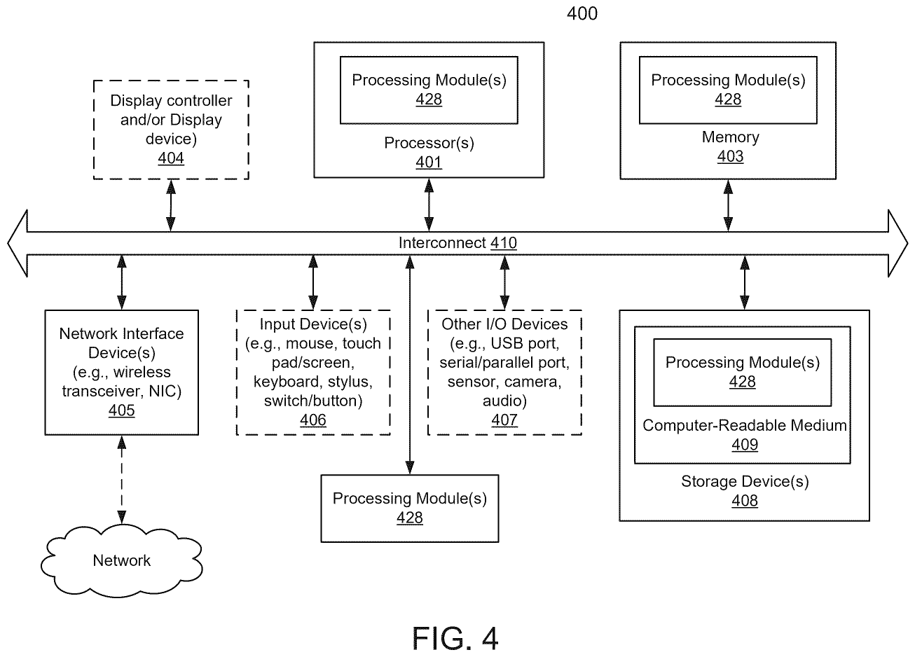

Any of (and/or components thereof) data processing systems 100, AI model manager 102, and downstream consumers 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

Communication system 104 may allow any of data processing systems 100, AI model manager 102, and downstream consumers 106 to communicate with one another (and/or with other devices not illustrated in FIG. 1). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to AI model manager 102 and downstream consumers 106 via the Internet. Data processing systems 100, AI model manager 102, downstream consumers 106, and/or communication system 104 may be adapted to perform one or more protocols for communicating via communication system 104.

While illustrated in FIG. 1 as including a limited number of specific components, a system in accordance with an embodiment may include fewer, additional, and/or different components than those illustrated therein.

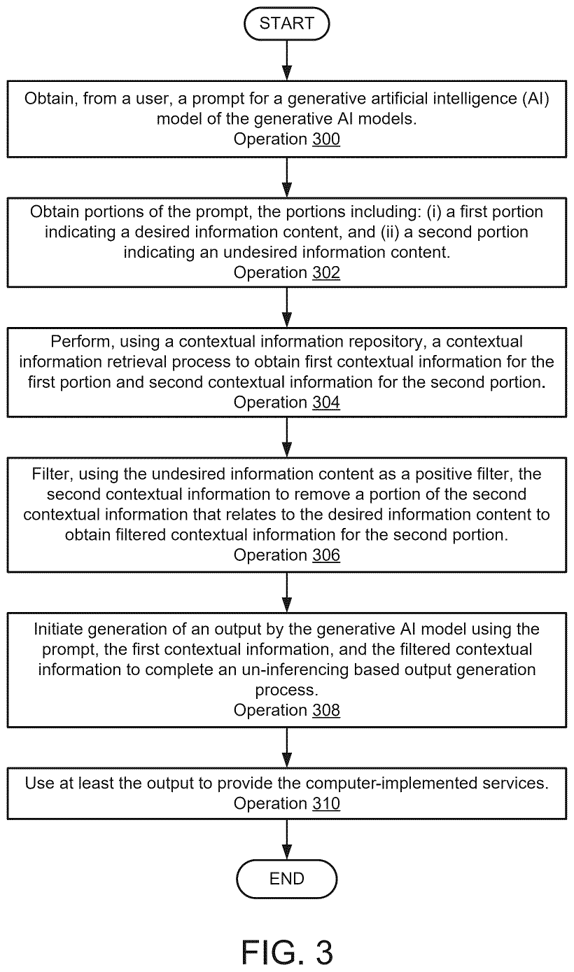

While providing their functionality, any of data processing systems 100, AI model manager 102, and/or downstream consumers 106 may provide all or a portion of the methods shown in FIGS. 2A-3.

To further clarify embodiments disclosed herein, data flow diagrams in accordance with an embodiment are shown in FIGS. 2A-2D. In these diagrams, flows of data and processing of data are illustrated using different sets of shapes. A first set of shapes (e.g., 202, 206, etc.) is used to represent data structures, a second set of shapes (e.g., 204, 220, etc.) is used to represent processes performed using and/or that generate data, a third set of shapes (e.g., 216) is used to represent generative AI models and/or other types of models, and a fourth set of shapes (e.g., 224) is used to represent large scale data structures such as databases.

Turning to FIG. 2A, a first data flow diagram in accordance with an embodiment is shown. The first data flow diagram may illustrate data used in and data processing performed in obtaining a prompt (e.g., prompt 202) for a generative AI model and obtaining portions of the prompt (e.g., first portion 206, second portion 208) as part of providing computer-implemented services using generative AI models.

As part of providing the computer-implemented services, a user (e.g., downstream consumer 106A, which may include a person and/or software program) may initiate a chat session (e.g., with an AI agent hosted by one or more of downstream consumers 106). During the chat session, prompt 202 may be obtained from the user. Prompt 202 may include a query for a generative AI model, and may be used by the generative AI model to generate an output responsive to prompt 202. Prompt 202 may include any type of data modality (e.g., images, audio, video, text). Refer to the description of FIG. 2D for additional details regarding the generative AI model.

Prompt 202 may be obtained, from the user, via an interaction between the user and a graphical user interface (GUI). The GUI may display, to the user, a record of the chat session that includes: (i) prompts provided by the user during the chat session (e.g., including prompt 202), and/or (ii) outputs generated by the generative AI model during the chat session.

Prompt 202 may be used to perform portion identification process 204. During portion identification process 204, portions of prompt 202 may be obtained, which may include: (i) first portion 206, and (ii) second portion 208. For example, first portion 206 may indicate a desired information content (e.g., an information content which is desired by the user to be included in the output), and second portion 208 may indicate an undesired information content (e.g., an information content which is not desired by the user to be included in the output).

Performing portion identification process 204 may include identifying, using a second generative AI model (not shown), user sentiments for the portions of prompt 202. The user sentiments may indicate the desired information content and the undesired information content. The user sentiments may be identified by analyzing words, phrases, and/or other features of prompt 202 by the second generative AI model (e.g., an LLM). Portion identification process 204 may be performed via other method and/or other entities without departing from embodiments disclosed herein.

For example, a user sentiment indicating the desired information content may be identified by the second generative AI model based on text such as “provide information regarding . . . ,” “can you tell me about . . . ,” “I would like information about . . . ,” etc. A user sentiment indicating the undesired information content may be identified by the second generative AI model based on text such as “do not tell me about . . . ,” “excluding . . . ,” “not . . . ,” etc.

For example, the user may be an employee at a company that sells computers. The employee may, during a chat session with an AI agent, provide the prompt: “what is the predicted net profit next quarter?” To provide an output, contextual information for the prompt may be obtained from a contextual information repository. The contextual information may include data chunks from past sales reports, market trend documents for computers and various components of the computers, and/or any other information which may provide context to the prompt. Based on the prompt and the contextual information, an output may be provided to the employee, which may include the text: “the predicted net profit next quarter is $3.1 million.”

When generating the output, it may be assumed that any contextual information obtained that is sufficiently similar to the prompt is to be used to provide context for the prompt. However, the employee may desire that portions of the contextual information are not used for output generation (e.g., may desire certain assumptions are removed from output generation). For example, a portion of data chunks in the contextual information repository may relate to an impact of a sales tax on the net profit. However, the employee may desire to know the net profit without the impact of the sales tax (e.g., the employee may want the assumption that the sales tax will impact net profit removed from output generation). For example, the employee may want the assumption that the sales tax will impact the net profit next quarter removed from output generation following a policy update abolishing the sales tax. Thus, the employee may provide the prompt: “what is the predicted net profit next quarter, excluding the impact of the sales tax?”

The prompt obtained from the employee may be provided as input to the second generative AI model, which may identify sentiments of the employee indicating a desired information content (e.g., the predicted net profit next quarter) and an undesired information content (e.g., the impact of the sales tax). As a result, portions of the prompt may be obtained, which may include a first portion (e.g., “what is the predicted net profit next quarter”) and a second portion (e.g., “the impact of the sales tax”).

Turning to FIG. 2B, a second data flow diagram in accordance with an embodiment is shown. The second data flow diagram may illustrate data used in and data processing performed in performing a contextual information retrieval process to obtain first contextual information 226 and second contextual information 228 for a prompt (e.g., prompt 202 discussed in FIG. 2A, not shown).

Performing the contextual information retrieval process may include: (i) performing first contextual information retrieval process 220 to obtain first contextual information 226 for first portion 206, and (ii) performing second contextual information retrieval process 222 to obtain second contextual information 228 for second portion 208. First contextual information retrieval process 220 and second contextual information retrieval process 222 may be independent similarity based search processes with respect to first portion 206 and second portion 208, respectively.

To perform the similarity based search processes (e.g., first contextual information retrieval process 220 and second contextual information retrieval process 222), contextual information repository 224 may be used. Contextual information repository 224 may include any type of data repository, such as a RAG database, and may include data which may be relevant to prompts provided to generative AI models. Data chunks from contextual information repository 224 may be selected based on the results of the similarity based search processes and used to provide context to prompt 202.

For example, during first contextual information retrieval process 220, a first similarity based search process may be performed using contextual information repository 224. To do so, an embedding generation process may be performed to obtain a first embedding, the first embedding including an inference model-ingestible representation of first portion 206 (e.g., a first vector). Performing the embedding generation process may include using first portion 206 and any function and/or method usable to convert text (and/or other data modalities) into numerical vectors.

Using the first embedding, data chunks from contextual information repository 224 may be identified that are similar to the first embedding based on similarity criteria. The similarity criteria may include any similarity criteria, such as a threshold level of similarity, and may be obtained from a subject matter expert and/or any other source. The data chunks may be ranked based on similarity to the first embedding (e.g., from most similar to the first embedding to least similar to the first embedding) to obtain a ranking of the data chunks. At least one data chunk may then be selected based on at least the ranking of the data chunks, and may be used as first contextual information 226.

Performing second contextual information retrieval process 222 may include performing a second similarity based search process using contextual information repository 224 via methods similar to those described with respect to performing first contextual information retrieval process 220. To do so, the embedding generation process may be performed to obtain a second embedding, the second embedding including an inference model-ingestible representation of second portion 208 (e.g., a second vector). Performing the embedding generation process may include using second portion 208 and any function and/or method usable to convert text (and/or other data modalities) into numerical vectors.

Using the second embedding, data chunks from contextual information repository 224 may be identified that are similar to the second embedding based on similarity criteria. The similarity criteria may be similar to the similarity criteria discussed with respect to performing first contextual information retrieval process 220. The data chunks may be ranked based on similarity to the second embedding (e.g., from most similar to the second embedding to least similar to the second embedding) to obtain a ranking of the data chunks. At least one data chunk may then be selected based on at least the ranking of the data chunks, and may be used as second contextual information 228.

Returning to the example discussed in FIG. 2A, the employee at the company may provide the prompt “what is the predicted net profit next quarter, excluding the impact of the sales tax?” A first portion of the prompt including the text: “what is the predicted net profit next quarter,” and a second portion of the prompt including the text: “the impact of the sales tax” may be obtained. A first contextual information retrieval process may be performed to obtain first contextual information for the first portion. The first contextual information may include data chunks obtained from sales revenue documents, sales expense documents, market trends documents, etc. A second contextual information retrieval process may also be performed to obtain second contextual information for the second portion. The second contextual information may include data chunks from documents indicating amounts the company paid for the sales tax last quarter, documents predicting any changes in an amount the company will pay for the sales tax next quarter, etc.

Turning to FIG. 2C, a third data flow diagram in accordance with an embodiment is shown. The third data flow diagram may illustrate data used in and data processing performed in filtering second contextual information 228 to obtain filtered contextual information 232. Filtered contextual information 232 may then be used to generate ingest package 236 usable by the generative AI model to generate an output responsive to prompt 202.

To obtain filtered contextual information 232, contextual information filtering process 230 may be performed. During contextual information filtering process 230, second contextual information 228 may be filtered using: (i) the undesired information content (e.g., indicated by the second portion of prompt 202) as a positive filter, and/or (ii) the desired information content (e.g., indicated by first portion 206 of prompt 202) as a negative filter. In a first example, filtering second contextual information 228 using the undesired information content as the positive filter may include retaining portions of second contextual information 228 that relate to the undesired information content. In a second example, filtering second contextual information 228 using the desired information content as the negative filter may include removing portions from second contextual information 228 that relate to the desired information content. As a result of performing contextual information filtering process 230, filtered contextual information 232 may be obtained.

By filtering second contextual information 228, a portion of second contextual information 228 may be removed that relates to the desired information content. Doing so may reduce a likelihood of providing the generative AI model contextual information for each portion of prompt 202 that results in conflicts and/or other negative impacts on output generation. For example, the portion of second contextual information 228 that relates to the desired information context may have a reduced likelihood of being trustworthy, accurate, and/or otherwise be usable to elicit a desired output from the generative AI model. By removing the portion from second contextual information 228, a likelihood that the output generated for prompt 202 meets the expectations of the user may be improved.

Performing contextual information filtering process 230 may include making a determination regarding whether a second portion of second contextual information 228 relates to the desired information content. For example, a second generative AI model (e.g., an LLM) may be used to analyze second contextual information 228 to determine whether the second portion relates to the desired information content, and/or any other method may be used (e.g., based on any similarity criteria usable to determine whether the second portion sufficiently relates to the desired information content). If it is determined that the second portion does relate to the desired information content, the second portion may be removed to obtain filtered contextual information 232. If it is determined that the second portion does not relate to the desired information content, the second portion may be retained to obtain filtered contextual information 232.

For example, a user may work in market research and may seek information from a generative AI model regarding the market for electric cars. However, the user may desire that the generative AI model does not assume that tariffs will impact the market for electric cars. Thus, the user may provide a prompt including the text: “tell me about the market for electric cars next year, do not include effects from tariffs.” In this example, it may be determined that the desired information content is “the market for electric cars next year,” and the undesired information content is “effects from tariffs.” First contextual information may be obtained for “the market for electric cars next year” and second contextual information may be obtained for “effects from tariffs.” The second contextual information may be filtered so that only portions relating to “effects from tariffs” are retained (e.g., portions related to “the market for electric cars next year” may be removed).

Filtered contextual information 232 may be used to perform ingest package generation process 234. During ingest package generation process 234, ingest package 236 may be obtained. Ingest package 236 may include: (i) prompt 202, (ii) first contextual information 226 (e.g., for the first portion of prompt 202), and (iii) filtered contextual information 232 (e.g., for the second portion of prompt 202). Obtaining ingest package 236 may be performed as part of a retrieval-augmented generation (RAG) process, and may include generating a data structure to be used as input for the generative AI model.

Ingest package 236 may then be used to generate an output responsive to prompt 202 using the generative AI model. For additional information regarding generating the output, refer to the description of FIG. 2D.

Turning to FIG. 2D, a fourth data flow diagram in accordance with an embodiment is shown. The fourth data flow diagram may illustrate data used in and data processing performed in initiating generation of an output by the generative AI model (e.g., 216) to complete an un-inferencing based output generation process. The output may be used as part of providing computer-implemented services to a user (e.g., during a chat session).

To do so, output generation process 212 may be performed. During output generation process 212, generation of output 214 by generative AI model 216 may be initiated by feeding ingest package 236 into generative AI model 216 as input.

Generative AI model 216 may be an LLM (e.g., a neural network inference model) trained to generate language, understand language, and/or otherwise process requests related to languages. Generative AI model 216 may have been previously trained using training data and any training process (e.g., a global optimization process using gradient descent), the training data indicating goals for outputs generated by generative AI model 216 (e.g., outputs). Parameters of generative AI model 216 may be selected using an optimization process (e.g., an objective function may be defined in terms of the training data and outputs generated by generative AI model 216, and a global optimization method such as gradient descent may be used to identify parameters that most faithfully reproduce the trends in the training data). Once the parameters of generative AI model 216 are set, then generative AI model 216 may be used to generate outputs (e.g., responses) based on input data (e.g., ingest packages). Generative AI model 216 may be trained using other methods without departing from embodiments disclosed herein.

Generative AI model 216 may generate output 214 using ingest package 236 to complete the un-inferencing based output generation process. An AI agent (e.g., a software program) may retrieve output 214 and may populate a chat window on the GUI using output 214 as part of the chat session.

By using first contextual information for the first portion of the prompt having the desired information content and filtered contextual information for the second portion of the prompt having the undesired information content as part of ingest package 236, there may be an increased likelihood that generative AI model 216 generates output 214 which meets the expectations of the user. At least output 214 may then be used to provide the computer-implemented services.

Thus, by implementing the data flows shown in FIGS. 2A-2D, a system in accordance with embodiments disclosed herein may have an increased likelihood of generating an output for a prompt using a generative AI model that meets the expectations of a user. To do so, first contextual information may be obtained for a first portion of the prompt indicating a desired information content, and second contextual information may be obtained for a second portion of the prompt having an undesired information content. The second contextual information may be filtered to remove a portion that relates to the desired information content to obtain filtered contextual information. The first contextual information, the filtered contextual information, and the prompt may be used as part of an ingest package for a generative AI model to generate the output. Consequently, a reliability and/or usefulness of the output may be increased for the user.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage a data processing system. FIG. 3 illustrates methods that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of providing computer-implemented services using generative AI models in accordance with an embodiment is shown. The method may be performed, for example, by any of the components of the system of FIG. 1, and/or other components not shown therein.

At operation 300, a prompt for a generative artificial intelligence (AI) model of the generative AI models may be obtained from a user. Obtaining the prompt may include: (i) obtaining, from the user, the prompt as part of a chat session via interactions between the user and a GUI, (ii) reading the prompt from storage, (iii) receiving the prompt from another entity via a communication system, and/or other methods.

Obtaining the prompt as part of the chat session may include receiving the prompt from the user as input into the GUI using any number of human interface devices operably connected to a device operated by the user. For example, obtaining the prompt may include: (i) obtaining the prompt as text from the user using a keyboard, (ii) obtaining the prompt from the user via a voice to text feature using a microphone, and/or (iii) other methods.

At operation 302, portions of the prompt may be obtained, the portions including: (i) a first portion indicating a desired information content, and (ii) a second portion indicating an undesired information content. Obtaining the portions may include: (i) identifying, using a second generative AI model (e.g., such as an LLM), user sentiments for the portions of the prompt, the user sentiments indicating the desired information content and the undesired information content, (ii) obtaining the first portion and the second portion based on the user sentiments, (iii) identifying the portions using any other type of natural language processing, (iv) identifying the portions using a rule set for portion identification (e.g., based on inclusion of words and/or phases within the prompt), (v) reading the portions from storage, (vi) receiving the portions from another entity, and/or (vii) other methods.

Identifying the user sentiments may include: (i) providing the prompt as ingest to the second generative AI model, (ii) prompting the second generative AI model to identify the user sentiments, (iii) receiving the user sentiments as output from the second generative AI model, (iv) providing the prompt to another entity responsible for hosting the second generative AI model and receiving the user sentiments in response to the providing, and/or (v) other methods.

Obtaining the first portion and the second portion based on the user sentiments may include: (i) identifying, based on the user sentiments, the desired information content and the undesired information content, (ii) identifying the first portion based on the portion of the prompt indicating the desired information content, (iii) identifying the second portion based on the portion of the prompt indicating the undesired information content, (iv) prompting the second generative AI model to identify the first portion and the second portion based on the user sentiments, and/or (v) other methods.

At operation 304, a contextual information retrieval process may be performed using a contextual information repository to obtain first contextual information for the first portion and second contextual information for the second portion. Performing the contextual information retrieval process may include: (i) performing a first contextual information retrieval process to obtain the first contextual information for the first portion, (ii) performing a second contextual information retrieval process to obtain the second contextual information for the second portion, (iii) providing the first portion and the second portion to another entity responsible for performing the contextual information retrieval process and receiving the first contextual information and the second contextual information in response, and/or (iv) other methods.

Performing the second contextual information process may include: (i) performing an embedding generation process for the second portion to obtain an embedding, the embedding including an inference model-ingestible representation of the second portion, (ii) identifying data chunks from the contextual information repository that are similar to the embedding based on similarity criteria, (iii) ranking the data chunks based on similarity to the embedding to obtain a ranking, (iv) selecting at least one data chunk to be used as the second contextual information based on at least the ranking, (v) providing the second portion to another entity and receiving the second contextual information in response, and/or (iv) other methods.

Performing the embedding generation process for the second portion may include:
(i) generating the embedding using the second portion and any function and/or method usable to convert the second portion into an inference model-ingestible representation of the second portion (e.g., a numerical vector), (ii) reading the embedding from storage, (iii) receiving the embedding from another entity, and/or (iv) other methods.

Identifying data chunks from the contextual information repository that are similar to the embedding based on similarity criteria may include: (i) obtaining the similarity criteria (e.g. receiving the similarity criteria from another entity such as a subject matter expert, reading the similarity criteria from storage, generating the similarity criteria), (ii) comparing a value of the embedding to values of data chunks from the contextual information repository to identify the data chunks that meet the similarity criteria, and/or (iii) other methods.

Ranking the data chunks may include: (i) assigning each of the data chunks a similarity score, the similarity score indicating a degree of similarity between each of the data chunks and the embedding, (ii) ordering the data chunks based on similarity score (e.g., from a highest similarity score to a lowest similarity score) to obtain the ranking, and/or (iii) other methods.

Selecting at least one data chunk to be used as the second contextual information based on at least the ranking may include: (i) identifying the at least one data chunk based on at least the ranking and any criteria and/or thresholds for selecting data chunks for use as contextual information (e.g., based on a threshold quantity of data chunks needed to provide sufficient context for the prompt), (ii) using the at least one data chunk as the second contextual information, and/or (iii) other methods.

Performing the first contextual information process may include processes and methods similar to performing the second contextual information process. Performing the first contextual information process may include: (i) performing an embedding generation process for the first portion to obtain a second embedding, the second embedding including an inference model-ingestible representation of the first portion, (ii) identifying data chunks from the contextual information repository that are similar to the second embedding based on similarity criteria, (iii) ranking the data chunks based on similarity to the second embedding to obtain a second ranking, (iv) selecting at least one data chunk to be used as the first contextual information based on at least the second ranking, (v) providing the first portion to another entity and receiving the first contextual information in response, and/or (iv) other methods.

At operation 306, the second contextual information may be filtered using the undesired information content as a positive filter to remove a portion of the second contextual information that relates to the desired information content to obtain filtered contextual information for the second portion. Filtering the second contextual information may include: (i) performing any type and quantity of analysis techniques to identify the portion of the second contextual information that relates to the desired information content (e.g., and/or that does not relate to the undesired information content), (ii) removing the portion from the second contextual information (e.g., deleting the portion, providing the second contextual information to another entity responsible for removing the portion) to obtain the filtered contextual information, and/or (iii) other methods.

Filtering the second contextual information may also include making a determination regarding whether a second portion of the second contextual information relates to the desired information content. Making the determination may include: (i) performing any number and type of analysis processes using the desired information content to determine whether the second portion relates to the desired information content, (ii) providing at least the second contextual information to another entity and receiving the determination in response, (iii) reading the determination from storage, and/or (iv) other methods.

If it is determined that the second portion of the second contextual information does relate to the desired information content, the second portion of the second contextual information may be removed to obtain the filtered contextual information. Removing the second portion may include: (i) deleting the second portion from the second contextual information to obtain the filtered contextual information, (ii) generating a data structure that does not include the second portion and using the data structure as the filtered contextual information, (iii) providing the second contextual information to another entity responsible for removing the second portion and receiving the filtered contextual information in response, and/or (iv) other methods.

If it is determined that the second portion of the second contextual information does relates to the undesired information content (e.g., does not relate to the desired information content), the second portion of the second contextual information may be retained to obtain the filtered contextual information. Retaining the second portion may include: (i) not removing the second portion from the second contextual information, (ii) generating a data structure including the second portion and using the data structure as the filtered contextual information, and/or (iii) other methods.

At operation 308, generation of an output by the generative AI model may be initiated using the prompt, the first contextual information, and the filtered contextual information to complete an un-inferencing based output generation process. Initiating generation of the output may include: (i) obtaining, using the prompt, the first contextual information, and the filtered contextual information, an ingest package for the generative AI model, (ii) providing the ingest package to the generative AI model as input to be used to generate the output, and/or (iii) other methods. By initiating generation of the output, the output may be generated, and the un-inferencing based output generation process may be completed.

Obtaining the ingest package may include: (i) generating the ingest package (e.g., compiling the prompt, the first contextual information, and the filtered contextual information into a data structure), (ii) providing the prompt, the first contextual information, and the filtered contextual information to another entity responsible for generating the ingest package, (iii) reading the ingest package from storage, and/or (iv) other methods.

Providing the ingest package to the generative AI model as input may include: (i) providing the ingest package to an entity responsible for hosting and operating the generative AI model, (ii) feeding the ingest package into the generative AI model as input and obtaining a response as output from the generative AI model, and/or (iii) other methods.

Initiating generation of the output may also include performing, using the second portion, an un-inferencing process to obtain a temporarily updated instance of the generative AI model, the temporarily updated instance of the generative AI model being less influenced by the second portion than the generative AI model.

Performing the un-inferencing process may include at least one action selected from a list of actions consisting of: (i) negating embeddings corresponding to the second portion to obtain the temporarily updated instance of the generative AI model, (ii) adding, based on the second portion, a negation layer to an input layer of the generative AI model to obtain the temporarily updated instance of the generative AI model, (iii) adding, based on the second portion, the negation layer prior to an attention module of the generative AI model to obtain the temporarily updated instance of the generative AI model, (iv) adding, based on the second portion, the negation layer to a hidden layer of the attention module to obtain the temporarily updated instance of the generative AI model, and (v) removing (e.g., deleting) tokens that correspond to the second portion from a memory (e.g., attention) of the generative AI model.

Negating the embeddings may include: (i) obtaining the embeddings corresponding to the second portion (e.g., reading the embeddings from storage, obtaining the embeddings from another entity), (ii) multiplying each embedding by its corresponding un-inferencing weight and by negative one to flip a sign of the embedding, and/or (iii) other methods.

Adding the negation layer to the generative AI model may include: (i) identifying elements (e.g., neurons) of an input layer of the generative AI model that consume the second portion, (ii) performing an operation to modify a latent representation of the second portion prior to or following ingestion by the neurons of the input layer, and/or (iii) other methods. Modifying the latent representation may include changing attention values of the input (e.g., multiplying the attention values by negative one and the corresponding un-inferencing weights). By doing so, the second portion may be processed in a negated form (e.g., by the input layer, by a layer of neurons after the input layer).

Adding the negation layer (e.g., a layer that performs the modification of the information content) that feeds into the attention module may include methods similar to those described with respect to adding the negation layer to the input layer. However, the negation layer may be added to elements of the generative AI model that are located prior to an attention module of the generative AI model rather than in the input layer. Therefore, partially processed input data may pass through the negation layer prior to entering the attention module (e.g., attention layer) and/or after exiting the attention module. Adding the negation layer to the hidden layer of the attention module may include methods similar to those described with respect to adding the negation layer to the input layer. However, the negation layer may be added within a hidden layer of the attention module rather than to the input layer. Therefore, partially processed input data may enter the attention module, pass through the negation layer at some point within the attention module, and may exit the attention module having passed through the negation layer.

At operation 310, at least the output may be used to provide the computer-implemented services. Providing the computer-implemented services using at least the output may include: (i) populating the GUI with at least the output (e.g., as part of a chat session), (ii) making decisions based on at least the output, (iii) providing the output to another entity, (iv) selecting one or more actions based on the output and performing the one or more actions to update operation of a system, and/or (v) other methods.

The method may end following operation 310.

Thus, as illustrated above, embodiments disclosed herein may provide systems and methods usable to provide computer-implemented services using generative AI models. By obtaining contextual information for portions of a prompt and filtering a least a portion of the contextual information, a likelihood of generating an output which meets the expectations of a user may be improved.

Any of the components illustrated in FIGS. 1-2D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google® , Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer-implemented services using generative artificial intelligence (AI) models, the method comprising:
obtaining, from a user, a prompt for a generative AI model of the generative AI models;
obtaining portions of the prompt, the portions comprising:
a first portion indicating a desired information content, and
a second portion indicating an undesired information content;
performing, using a contextual information repository, a contextual information retrieval process to obtain first contextual information for the first portion and second contextual information for the second portion;
filtering, using the undesired information content as a positive filter, the second contextual information to remove a portion of the second contextual information that relates to the desired information content to obtain filtered contextual information for the second portion;
initiating generation of an output by the generative AI model using the prompt, the first contextual information, and the filtered contextual information to complete an un-inferencing based output generation process; and
using at least the output to provide the computer-implemented services.

2. The method of claim 1, wherein performing the contextual information retrieval process comprises:
performing a first contextual information retrieval process to obtain the first contextual information for the first portion; and
performing a second contextual information retrieval process to obtain the second contextual information for the second portion,
wherein the first contextual information retrieval process and the second contextual information retrieval process being independent similarity based search processes with respect to the first portion and the second portion, respectively.

3. The method of claim 2, wherein performing the second contextual information retrieval process comprises:
performing an embedding generation process for the second portion to obtain an embedding, the embedding comprising an inference model-ingestible representation of the second portion;
identifying data chunks from the contextual information repository that are similar to the embedding based on similarity criteria;
ranking the data chunks based on similarity to the embedding to obtain a ranking; and
selecting at least one data chunk to be used as the second contextual information based on at least the ranking.

4. The method of claim 1, wherein filtering the second contextual information comprises:
making a determination regarding whether a second portion of the second contextual information relates to the desired information content;
in a first instance of the determination in which the second portion of the second contextual information does relate to the desired information content:
removing the second portion of the second contextual information to obtain the filtered contextual information; and
in a second instance of the determination in which the second portion of the second contextual information relates to the undesired information content:
retaining the second portion of the second contextual information to obtain the filtered contextual information.

5. The method of claim 1, wherein obtaining the portions of the prompt comprises:
identifying, using a second generative AI model, user sentiments for the portions of the prompt, the user sentiments indicating the desired information content and the undesired information content; and
obtaining the first portion and the second portion based on the user sentiments.

6. The method of claim 1, wherein initiating generation of the output by the generative AI model comprises:
obtaining, using the prompt, the first contextual information, and the filtered contextual information, an ingest package for the generative AI model; and
providing the ingest package to the generative AI model as input to be used to generate the output.

7. The method of claim 6, wherein initiating generation of the output by the generative AI model further comprises:
performing, using the second portion, an un-inferencing process to obtain a temporarily updated instance of the generative AI model, the temporarily updated instance of the generative AI model being less influenced by the second portion than the generative AI model.

8. The method of claim 7, wherein performing the un-inferencing process comprises at least one action selected from a list of actions consisting of:
negating embeddings corresponding to the second portion to obtain the temporarily updated instance of the generative AI model;
adding, based on the second portion, a negation layer to an input layer of the generative AI model to obtain the temporarily updated instance of the generative AI model;
adding, based on the second portion, the negation layer prior to an attention module of the generative AI model to obtain the temporarily updated instance of the generative AI model; and
adding, based on the second portion, the negation layer to a hidden layer of the attention module to obtain the temporarily updated instance of the generative AI model.

9. The method of claim 1, wherein obtaining the prompt for the generative AI model comprises:
obtaining, from the user, the prompt as part of a chat session via interactions between the user and a graphical user interface (GUI).

10. The method of claim 1, wherein the generative AI model is a large language model (LLM).

11. The method of claim 1, wherein the prompt comprises at least one type of data modality selected from a list of types of data modalities consisting of:
text;
image;
video; and
audio.

12. A non-transitory machine-readable medium having instructions stored therein, which when executed by a processor, cause the processor to perform operations for providing computer-implemented services using generative artificial intelligence (AI) models, the operations comprising:
obtaining, from a user, a prompt for a generative AI model of the generative AI models;
obtaining portions of the prompt, the portions comprising:
a first portion indicating a desired information content, and
a second portion indicating an undesired information content;
performing, using a contextual information repository, a contextual information retrieval process to obtain first contextual information for the first portion and second contextual information for the second portion;
filtering, using the undesired information content as a positive filter, the second contextual information to remove a portion of the second contextual information that relates to the desired information content to obtain filtered contextual information for the second portion;
initiating generation of an output by the generative AI model using the prompt, the first contextual information, and the filtered contextual information to complete an un-inferencing based output generation process; and
using at least the output to provide the computer-implemented services.

13. The non-transitory machine-readable medium of claim 12, wherein performing the contextual information retrieval process comprises:
performing a first contextual information retrieval process to obtain the first contextual information for the first portion; and
performing a second contextual information retrieval process to obtain the second contextual information for the second portion,
wherein the first contextual information retrieval process and the second contextual information retrieval process being independent similarity based search processes with respect to the first portion and the second portion, respectively.

14. The non-transitory machine-readable medium of claim 13, wherein performing the second contextual information retrieval process comprises:
performing an embedding generation process for the second portion to obtain an embedding, the embedding comprising an inference model-ingestible representation of the second portion;
identifying data chunks from the contextual information repository that are similar to the embedding based on similarity criteria;
ranking the data chunks based on similarity to the embedding to obtain a ranking; and
selecting at least one data chunk to be used as the second contextual information based on at least the ranking.

15. The non-transitory machine-readable medium of claim 12, wherein filtering the second contextual information comprises:
making a determination regarding whether a second portion of the second contextual information relates to the desired information content;
in a first instance of the determination in which the second portion of the second contextual information does relate to the desired information content:
removing the second portion of the second contextual information to obtain the filtered contextual information; and
in a second instance of the determination in which the second portion of the second contextual information relates to the undesired information content:
retaining the second portion of the second contextual information to obtain the filtered contextual information.

16. A data processing system, comprising:
a processor; and
a memory coupled to the processor to store instructions, which when executed by the processor, cause the processor to perform operations for providing computer-implemented services using generative artificial intelligence (AI) models, the operations comprising:
obtaining, from a user, a prompt for a generative AI model of the generative AI models;
obtaining portions of the prompt, the portions comprising:
a first portion indicating a desired information content, and
a second portion indicating an undesired information content;
performing, using a contextual information repository, a contextual information retrieval process to obtain first contextual information for the first portion and second contextual information for the second portion;
filtering, using the undesired information content as a positive filter, the second contextual information to remove a portion of the second contextual information that relates to the desired information content to obtain filtered contextual information for the second portion;
initiating generation of an output by the generative AI model using the prompt, the first contextual information, and the filtered contextual information to complete an un-inferencing based output generation process; and
using at least the output to provide the computer-implemented services.

17. The data processing system of claim 16, wherein performing the contextual information retrieval process comprises:
performing a first contextual information retrieval process to obtain the first contextual information for the first portion; and
performing a second contextual information retrieval process to obtain the second contextual information for the second portion,
wherein the first contextual information retrieval process and the second contextual information retrieval process being independent similarity based search processes with respect to the first portion and the second portion, respectively.

18. The data processing system of claim 17, wherein performing the second contextual information retrieval process comprises:
performing an embedding generation process for the second portion to obtain an embedding, the embedding comprising an inference model-ingestible representation of the second portion;
identifying data chunks from the contextual information repository that are similar to the embedding based on similarity criteria;
ranking the data chunks based on similarity to the embedding to obtain a ranking; and
selecting at least one data chunk to be used as the second contextual information based on at least the ranking.

19. The data processing system of claim 16, wherein filtering the second contextual information comprises:
making a determination regarding whether a second portion of the second contextual information relates to the desired information content;
in a first instance of the determination in which the second portion of the second contextual information does relate to the desired information content:
removing the second portion of the second contextual information to obtain the filtered contextual information; and
in a second instance of the determination in which the second portion of the second contextual information relates to the undesired information content:
retaining the second portion of the second contextual information to obtain the filtered contextual information.

20. The data processing system of claim 16, wherein obtaining the portions of the prompt comprises:
identifying, using a second generative AI model, user sentiments for the portions of the prompt, the user sentiments indicating the desired information content and the undesired information content; and
obtaining the first portion and the second portion based on the user sentiments.
